(19) United States
(12) Patent Application Publication
(10) Pub. No.: US 2026/0350767 A1
(43) Pub. Date: Nov. 5, 2026

(54) METHOD, APPARATUS, DEVICE, COMPUTER READABLE STORAGE MEDIUM AND PRODUCT FOR LIQUID RENDERING

(71) Applicant: Beijing Zitiao Network Technology Co., Ltd., Beijing (CN)

(72) Inventor: Zehua Bao, Beijing (CN)

(21) Appl. No.: 19/116,360

(22) PCT Filed: Sep. 14, 2023
(86) PCT No.: PCT/CN2023/118886

§ 371 Date: Mar. 27, 2025

(30) Foreign Application Priority Data
Sep. 30, 2022 (CN) 202211215056.X

(51) Int. Cl. G06T 5/94

(52) U.S. Cl. CPC G06T 5/94

(57) ABSTRACT

The embodiments of the disclosure provide a method, an apparatus, an electronic device, a computer-readable storage medium, a computer program product and a computer program for liquid rendering. The method includes: in response to a liquid rendering request triggered by a user, obtaining initial data generated based on an interactive operation triggered by the user; calculating, based on the initial data, target rendering data for rendering predetermined content to be rendered, wherein the content to be rendered includes liquid to be rendered and at least one object to be rendered generated by the liquid to be rendered in response to the interactive operation; and rendering the content to be rendered based on the target rendering data to obtain rendered target content.

### CROSS REFERENCE

This application claims priority to Chinese Patent Application No. 202211215056.X, entitled “METHOD, APPARATUS, DEVICE, COMPUTER READABLE STORAGE MEDIUM AND PRODUCT FOR LIQUID RENDERING,” filed before the Chinese Patent Office on Sep. 30, 2022, the entire content of which is incorporated herein by reference.

### FIELD

The embodiments of the disclosure relate to the technical field of image processing, in particular to a method, an apparatus, an electronic device, a computer-readable storage medium, a computer program product and a computer program for liquid rendering.

### BACKGROUND

In many display scenarios, rendering of liquid is involved. Existing methods of liquid rendering generally render liquid and liquid filled containers respectively. For example, rendering a water body for the part of the water body, and rendering a glass for the part of the container.

However, the above rendering method cannot interact with the user in real time, and the display effect is relatively single.

### SUMMARY

The embodiments of the disclosure provide a method, an apparatus, an electronic device, a computer-readable storage medium, a computer program product and a computer program for liquid rendering, which are used for solving the problems that an existing method of liquid rendering is relatively single in display effect and does not support real-time interaction.

According to a first aspect, an embodiment of the disclosure provides a method of liquid rendering, comprising:
in response to a liquid rendering request triggered by a user, obtaining initial data generated based on an interactive operation triggered by the user;
calculating, based on the initial data, target rendering data for rendering predetermined content to be rendered, wherein the content to be rendered comprises liquid to be rendered and at least one object to be rendered generated by the liquid to be rendered in response to the interactive operation; and
rendering the content to be rendered based on the target rendering data to obtain rendered target content.

According to a second aspect, an embodiment of the disclosure provides an apparatus for liquid rendering, comprising:
an obtaining module, configured to in response to a liquid rendering request triggered by a user, obtain initial data generated based on an interactive operation triggered by the user;
a calculation module, configured to calculate, based on the initial data, target rendering data for rendering predetermined content to be rendered, wherein the content to be rendered comprises liquid to be rendered and at least one object to be rendered generated by the liquid to be rendered in response to the interactive operation; and
a rendering module, configured to render the content to be rendered based on the target rendering data to obtain rendered target content.

According to a third aspect, an embodiment of the disclosure provides an electronic device, comprising: a processor and a memory;
the memory storing computer executable instructions;
wherein the processor executes the computer executable instructions stored in the memory to cause the processor to execute the method of liquid rendering according to the first aspect and various possible designs of the first aspect.

According to a fourth aspect, an embodiment of the disclosure provides a computer-readable storage medium storing computer executable instructions, which, when executed by a processor, implement the method of liquid rendering according to the first aspect and various possible designs of the first aspect.

According to a fifth aspect, an embodiment of the disclosure provides a computer program product, comprising a computer program, wherein the computer program, when executed by a processor, implements the method of liquid rendering according to the first aspect and various possible designs of the first aspect.

According to a sixth aspect, an embodiment of the disclosure provides a computer program, wherein the computer program, when executed by a processor, implements the method of liquid rendering according to the first aspect and various possible designs of the first aspect.

### BRIEF DESCRIPTION OF DRAWINGS

In order to more clearly illustrate embodiments of the disclosure or the technical solutions in the prior art, the accompanying drawings used in the description of embodiments or the prior art will be briefly introduced below, and it will be apparent that the drawings in the following description are some embodiments of the disclosure, and those skilled in the art may also obtain other drawings according to these drawings without creative labor.

FIG. 1 is a schematic flowchart of a method of liquid rendering according to an embodiment of the disclosure.

FIG. 2 is a schematic flowchart of a method of liquid rendering according to another embodiment of the disclosure.

FIG. 3 is a schematic diagram of tension according to an embodiment of the disclosure.

FIG. 4 is a schematic flowchart of a method of liquid rendering according to another embodiment of the disclosure.

FIG. 5 is a schematic diagram of a target mask according to an embodiment of the disclosure.

FIG. 6 is a schematic flowchart of a method of liquid rendering according to another embodiment of the disclosure.

FIG. 7 is a schematic diagram of texture sampling coordinate division according to an embodiment of the disclosure.

FIG. 8 is a schematic diagram of a first bubble to be processed according to an embodiment of the disclosure.

FIG. 9 is a schematic diagram of a third bubble to be processed according to an embodiment of the disclosure.

FIG. 10 is a schematic diagram of a target bubble according to an embodiment of the disclosure.

FIG. 11 is a schematic structural diagram of an apparatus for liquid rendering according to an embodiment of the disclosure.

FIG. 12 is a schematic structural diagram of an electronic device according to an embodiment of the disclosure.

### DETAILED DESCRIPTION

In order to make the objectives, technical solutions and advantages of the embodiments of the disclosure clearer, the technical solutions in the embodiments of the disclosure will be clearly and completely described below with reference to the accompanying drawings in the embodiments of the disclosure. Obviously, the described embodiments are a part of the disclosed embodiments, not all of them. All other embodiments obtained by those skilled in the art based on the embodiments of the disclosure without creative efforts shall fall within the scope of the disclosure.

For the problems mentioned above that an existing method of liquid rendering is relatively single in display effect and does not support real-time interaction, the disclosure provides a method, an apparatus, an electronic device, a computer-readable storage medium, a computer program product and a computer program for liquid rendering.

It should be noted that the method, the apparatus, the electronic device, the computer-readable storage medium, the computer program product and the computer program for liquid rendering provided by the disclosure may be applied to a scene for rendering various liquids.

An existing method of liquid rendering generally renders liquid based on a predetermined value, and displays a rendering effect. The liquid rendering cannot be performed based on an interactive operation triggered by a user. In addition, when liquid rendering is performed by using the above method, only the rendered liquid is displayed, and the display effect is relatively single.

In the process of solving the above technical problem, the inventor finds, through research and discovery, obtains initial data generated by a user based on an interactive operation, and generates target rendering data for rendering content to be rendered based on the initial data. Therefore, in the process of human-computer interaction of a user, the liquid can present a display effect matched with the human-computer interaction, and the user experience is improved.

In addition, since some of the liquid will correspondingly generate effects such as bubbles and foams during a shaking process. For example, in practical applications, beer bubbles are generated when the beer is shaken, and the bubbles finally form a layer of beer foam. Therefore, in order to further optimize the effect of liquid rendering and increase the fidelity of liquid rendering, content to be rendered may be added. In addition to liquid to be rendered, the content to be rendered may further include foam to be rendered and bubbles to be rendered. The plurality of pieces of content to be rendered may be rendered based on target rendering data generated according to the initial data generated by the human-computer interaction.

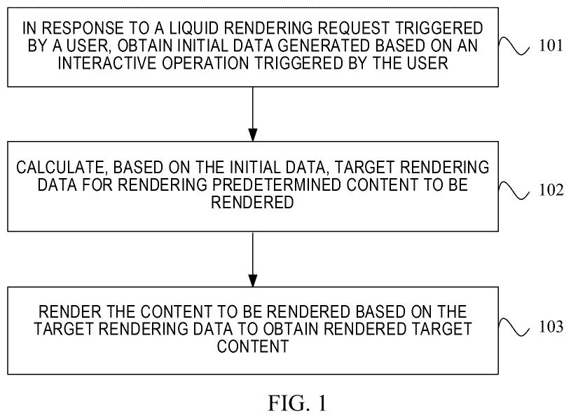

FIG. 1 is a schematic flowchart of a method of liquid rendering according to an embodiment of the disclosure. As shown in FIG. 1, the method includes:
Step 101: in response to a liquid rendering request triggered by a user, obtain initial data generated based on an interactive operation triggered by the user.

The executing body of the embodiment is an apparatus for liquid rendering, which may be coupled to a terminal device. Therefore, the rendering operation on the content to be rendered can be performed in response to the interactive operation triggered by the user. Optionally, the apparatus for liquid rendering may alternatively be coupled to a server, and the server may be communicatively connected to the terminal device, to obtain an interactive operation collected by the terminal device to perform a rendering operation on content to be rendered.

In the embodiment, the liquid to be rendered may be displayed on a display interface. The user may interact with the liquid to be rendered according to actual requirements. For example, the user may shake the terminal device, so that the liquid to be rendered presents a display effect that shakes along with shaking of the terminal device. Alternatively, the user may trigger the liquid to be rendered according to actual requirements, so that the liquid to be rendered presents a display effect in which a water ripple occurs in response to the trigger operation.

Correspondingly, in order to enable the liquid to be rendered to present the display effect, the user may trigger the liquid rendering request, so that the apparatus for liquid rendering can perform the rendering operation on the liquid to be rendered based on the liquid rendering request. The liquid rendering request may be generated automatically in response to interactive operation of the user on the liquid to be rendered, or may be generated after the user triggers the predetermined rendering control, which is not limited in the disclosure.

In order to enable the liquid to be rendered to present a display effect matching the interactive operation, after the liquid rendering request is obtained, initial data generated based on the interactive operation triggered by the user may be obtained based on the liquid rendering request.

The initial data may be motion data of the terminal device collected by a predetermined sensor on the terminal device. Alternatively, the initial data may also be triggering data of a user trigger screen collected by a predetermined sensor on the terminal device. This is not limited in the disclosure.
Step 102: calculate, based on the initial data, target rendering data for rendering predetermined content to be rendered, wherein the content to be rendered comprises liquid to be rendered and at least one object to be rendered generated by the liquid to be rendered in response to the interactive operation.

In practical applications, when liquid is shaken, objects such as bubbles and foams may be generated. For example, when the beer is shaken, beer bubbles are generated, and the bubbles finally form a layer of beer foam.

Therefore, in order to make the display effect of the liquid to be rendered more realistic, at least one object to be rendered may be correspondingly generated when the liquid to be rendered shakes with the interactive operation of the user or generates a water ripple. The object to be rendered may include at least one of bubbles to be rendered or foams to be rendered.

Correspondingly, to implement the rendering operation on the liquid to be rendered, after obtaining the initial data, the target rendering data for rendering the predetermined content to be rendered may be calculated based on the initial data.
Step 103: render the content to be rendered based on the target rendering data to obtain rendered target content.

In the embodiment, after the target rendering data is obtained through calculation, the content to be rendered may be rendered based on the target rendering data to obtain the rendered target content. Therefore, the target content can present a display effect of performing liquid shaking, generating bubbles and generating a layer of foam based on the interactive operation of the user. Alternatively, the target content can present a water ripple based on the interactive operation of the user, and display effects such as bubbles and foams are generated based on the water ripple. The display content in the liquid rendering operation is enriched, and the display effect of the liquid to be rendered is optimized.

Optionally, the calculation operation of the target rendering data may be implemented by a predetermined central processing unit (CPU). The rendering operation on the content to be rendered based on the target rendering data may be implemented by a predetermined graphics processing unit (GPU).

Optionally, based on any of the foregoing embodiments, step 101 includes:
in response to the liquid rendering request triggered by a movement operation of the user on a terminal device, collecting, by a predetermined sensor in the terminal device, motion data of the terminal device in a moving process; and
determine the motion data as the initial data, wherein the motion data comprises spatial pose transformation information and motion speed information.

In the embodiment, the user may trigger the liquid rendering request by moving the terminal device. In response to the liquid rendering request, motion data of the terminal device in the moving process may be collected through a predetermined sensor in the terminal device. The sensor includes, but is not limited to, a gyroscope, a speed sensor, an acceleration sensor, and the like, which is not limited in the disclosure.

After obtaining the motion data, the motion data may be determined as initial data, where the motion data includes spatial pose transformation information and motion speed information.

Optionally, the user may trigger the liquid rendering request by pressing, sliding and the like on a display interface of the terminal device. In response to the liquid rendering request, motion data of the terminal device in the moving process may be collected through a predetermined sensor in the terminal device. The sensor includes, but is not limited to, a pressure sensor and the like, which is not limited in the disclosure. Correspondingly, the motion data includes but is not limited to information such as a trigger position and a trigger force. The motion data may be determined as initial data.

According to the method of liquid rendering provided in the embodiment, the initial data generated by the user based on the interactive operation is obtained, and the target rendering data for rendering the liquid to be rendered and the at least one object to be rendered generated by the liquid to be rendered in response to the interactive operation is generated based on the initial data, so that rendering operations on the liquid to be rendered and the at least one object to be rendered can be implemented based on the target rendering data. Different rendering effects may be displayed based on the real-time interactive operation of the user. In addition, in addition to the liquid to be rendered, the rendered at least one object to be rendered may be displayed on the display interface, so that the display effect is enriched, and the user experience is improved.

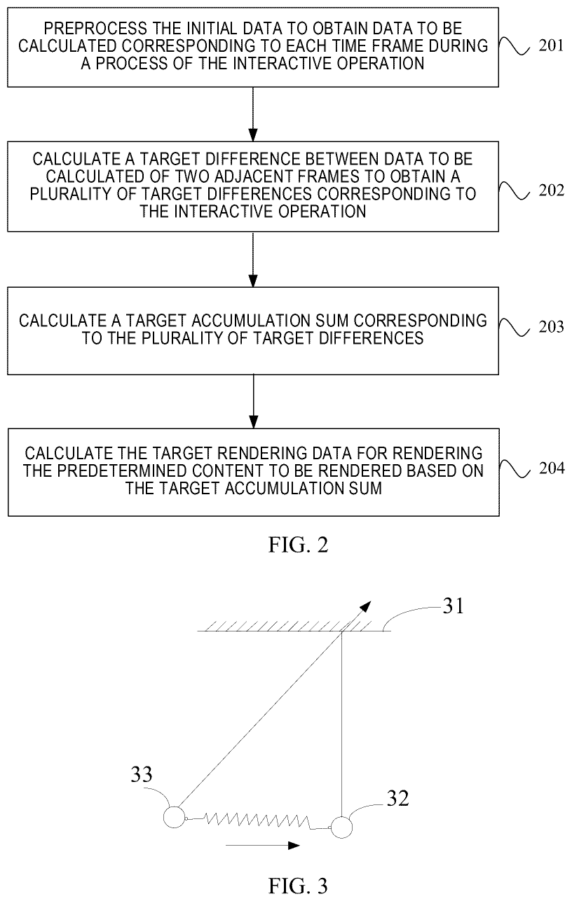

FIG. 2 is a schematic flowchart of a method of liquid rendering according to another embodiment of the disclosure. On the basis of any of the above embodiments, as shown in FIG. 2, Step 102 includes:
Step 201: preprocess the initial data to obtain data to be calculated corresponding to each time frame during a process of the interactive operation.
Step 202: calculate a target difference between data to be calculated of two adjacent frames to obtain a plurality of target differences corresponding to the interactive operation.
Step 203: calculate a target accumulation sum corresponding to the plurality of target differences.
Step 204: calculate the target rendering data for rendering the predetermined content to be rendered based on the target accumulation sum.

In the embodiment, after obtaining the initial data, the initial data may be preprocessed to extract data to be calculated corresponding to each time frame used to calculate the target rendering data in the initial data.

In practical applications, the more severe the movement, the more obvious the liquid shaking correspondingly, the more bubbles are generated, and the thicker the accumulated bubbles layer. Therefore, after the data to be calculated is obtained, a target difference between data to be calculated of two adjacent frames may be calculated to obtain a plurality of target differences corresponding to the interactive operation. The target accumulation sum corresponding to the plurality of target differences is calculated, so that the target accumulation sum can accurately represent the severity of the motion.

After the target accumulation sum is obtained, that is, after the severity of the motion generated by the interactive operation is determined, the target rendering data for rendering the predetermined content to be rendered may be calculated based the target accumulation sum. Therefore, the target rendering data can be matched with the severity of the motion, so that the final rendering effect can be attached to interactive operation of the user, and the user experience is improved.

Further, on the basis of any of the above embodiments, Step 204 includes:
determine target motion data corresponding to the target accumulation sum based on a predetermined correspondence between an accumulation sum and motion data of the content to be rendered;
calculate, based on the target motion data and user predetermined control data, the target rendering data for rendering the predetermined content to be rendered.

In the embodiment, the category of the liquid to be rendered may be different. For example, the liquid to be rendered may be water, beer, beverage, coffee, or the like. In the shaking process of different liquids, the shaking degree of the liquid, the speed of generating the bubbles, and the thickness of the accumulative foam are different. Therefore, to enable the final rendering effect to match the category of the content to be rendered, for different content to be rendered types, a correspondence between the accumulated sum and the motion data may be established in the content to be rendered type.

Therefore, after the target accumulation sum is calculated, the correspondence between the accumulation sum associated with the content to be rendered type and the motion data of the content to be rendered may be determined first. Determining the target accumulation sum and corresponding target motion data based on the correspondence between the accumulation sum and the motion data of the content to be rendered. The target motion data may include a generation speed of bubbles and/or foams, a shaking speed of the liquid, and the like.

In addition, after the bubbles, the foams and the like are generated, the bubbles and the foams gradually disappear over time. Therefore, the user can set the disappearance speed of the bubbles and the foams as the control data according to actual requirements.

Therefore, after the target accumulation sum and the corresponding target motion data are determined, the target rendering data for rendering the predetermined content to be rendered may be calculated based on the target motion data and the control data predetermined by the user. Therefore, in the process of shaking of the liquid, the display effect that the liquid shaking gradually becomes sharp and returns to calm, bubbles are generated and disappear, and the foam layer gradually generates and dissipates can be accurately simulated.

According to the method of liquid rendering provided by the embodiment, the data to be calculated corresponding to each time frame in the interactive operation process is determined, and the target rendering data of the content to be rendered is determined based on the target accumulation sum of the target difference between data to be calculated of two adjacent frames, so that, the content to be rendered can be accurately controlled to present the rendering effect matched with the interactive operation based on the interactive operation of the user, and the matching degree between the rendering effect and the interactive operation of the user is improved. In addition, by establishing a correspondence between the accumulated sum and the motion data of the content to be rendered, the target motion data can be accurately determined for different content to be rendered, and the applicability of the method of liquid rendering is improved.

Optionally, based on any of the foregoing embodiments, the content to be rendered includes liquid to be rendered and/or foam to be rendered generated by the liquid to be rendered in response to the interactive operation. The initial data includes motion speed information.

Step 201 includes:
For any movement point of the liquid to be rendered perpendicular to the surface of the liquid, calculating, based on a position vector from the movement point to a predetermined target point in the liquid to be rendered and a velocity vector of the movement point, tension information of the movement point on the predetermined target point in each time frame, and determining the tension information as the data to be calculated.

In the embodiment, the content to be rendered includes liquid to be rendered and/or foam to be rendered generated by the liquid to be rendered in response to interactive operation. Correspondingly, the initial data may include motion speed information, where the motion speed information includes speed information and acceleration information.

A plurality of motion points perpendicular to the liquid surface may be included in the liquid to be rendered, and each motion point may generate a pulling force on the center of mass of the liquid to be rendered. When the liquid to be rendered shakes with the interactive operation of the user, the position of the moving point relative to the surface of the liquid changes, and accordingly the pulling force of the moving point on the center of mass changes, and therefore, the pulling force can almost estimate the severity of the motion. Therefore, in order to make the rendered target content better fit the actual interactive operation of the user, the pulling force on the center of mass may be calculated for the motion point.

Therefore, for any movement point perpendicular to the surface of the liquid in the liquid to be rendered, based on a position vector between the predetermined target points in the liquid to be rendered and the velocity vector of the movement point, the tension information of the movement point on the predetermined target point in each time frame is calculated, and the tension information is determined as the data to be calculated. The predetermined target point may be specifically a mass point of the liquid to be rendered.

Specifically, the calculation of the tension information may be implemented according to Formula 1:

\vec{F}=−k\vec{x}−c\vec{v} (1)
where x is a position vector of the motion point to the predetermined target point, and v is a velocity vector of the motion point.

FIG. 3 is a schematic diagram of tension according to an embodiment of the disclosure. As shown in FIG. 3, the liquid to be rendered includes any movement point 32 perpendicular to the liquid surface 31 and a predetermined target point 33, where the predetermined target point 33 may be a center of mass of the liquid to be rendered. The motion point 32 can cause a damping tensile force to the predetermined target point 33.

Further, the acceleration \vec{a} may be obtained based on Formula 1, where the acceleration \vec{a} may be as shown in Formula 2:

$$\vec{a} = \frac{\vec{F}}{m} = - \frac{k}{m} \vec{x} - \frac{c}{m} \vec{v} \qquad ( 2 )$$

where x is a position vector of the motion point to the predetermined target point, v is a velocity vector of the motion point, and k/m and c/m are two freely adjusted parameters.

A standard second-order differential equation of motion with damping can be according to Formula 2, as shown in Formula 3:

$$\frac{{d}^{2} \vec{x}}{{dt}^{2}} + \frac{c}{m} \frac{d \vec{x}}{dt} + \frac{k}{m} \vec{x} = 0 \qquad ( 3 )$$

Optionally, the state of under-damping, overdamping, and critical damping can also be achieved by adjusting the parameters k/m and c/m, so that the liquid to be rendered exhibits different oscillation effects in the shaking process, the fluidity of the liquid to be rendered is presented, and the authenticity of the liquid to be rendered is increased.

According to the method of liquid rendering provided by the embodiment, the tension information of the motion point on the predetermined target point is used as the data to be calculated, so that the influence of the interactive operation of the user on the content to be rendered can be accurately determined. In turn, the target rendering data obtained through calculation based on the data to be calculated can improve the matching degree between the rendering effect and the interactive operation of the user.

Optionally, on the basis of any of the foregoing embodiments, the content to be rendered includes bubbles to be rendered generated by the liquid to be rendered in response to the interactive operation. The initial data includes spatial pose transformation information.

Step 201 includes:

Extracting a rotation Euler angle in a predetermined direction in each time frame from the spatial pose transformation information and determining the rotation Euler angle as the data to be calculated.

In the embodiment, the content to be rendered may include bubbles to be rendered generated by the liquid to be rendered in response to the interactive operation. The initial data includes spatial pose transformation information. Since the bubbles to be rendered are generated faster relative to the foams to be rendered, a more sensitive input response is required. Therefore, the Euler angle of the gyroscope which respond more quickly to motion can be selected as the data to be calculated.

Specifically, a rotation Euler angle in a predetermined direction in each time frame may be extracted from the spatial pose transformation information, and the rotation Euler angle may be determined as the data to be calculated. The rotating Euler angle in the predetermined direction may be a rotation Euler angle on the Z axis.

According to the method of liquid rendering provided in the embodiment, since the speed generated by the bubbles to be rendered is usually faster than the foams to be rendered, a more sensitive input response is required. By adopting the rotation Euler angle as the data to be calculated, the generation of the target rendering data can be achieved quickly in response to the interactive operation of the user. The efficiency of the liquid rendering operation is improved.

Optionally, on the basis of any of the foregoing embodiments, the content to be rendered includes foams to be rendered generated by the liquid to be rendered in response to the interactive operation. The target motion data includes a foam generation rate. The control data includes a foam dissipation rate.

The calculating target rendering data for rendering predetermined content to be rendered according to the target motion data and user predetermined control data includes:

Constructing a foam inventory pool based on the foam generation rate and the foam dissipation rate, the foam inventory pool including a thickness of foam layer in each time frame.

In the embodiment, the content to be rendered includes foams to be rendered generated by the liquid to be rendered in response to the interactive operation. The target motion data includes a foam generation rate. The control data includes a foam dissipation rate. The foam generation rate may be positively correlated with the degree of shaking caused by the user interactive operation on the content to be rendered, that is, the more severe the shaking, the faster the foam generation rate. The foam dissipation rate may be set by the user according to actual requirements.

In addition, the user may predetermine a height of the liquid to be rendered as y and define the sheet with the height belonging to (y−h, y) as the foam region. Since the liquid to be rendered will shake with the interactive operation of the user, and correspondingly the foam region is not a static rendering effect, h cannot be set to a constant value.

It is difficult to find out the physical phenomenon of foam generation, the more severe the liquid shaking, the faster the foams are generated, the longer the shaking time is, the thicker the foams thickness. However, it is usually not infinitely accumulated, and after the liquid is stationary for a period of time, the foam disappears. Based on the above analysis, a foam inventory pool may be provided. The foam inventory pool requires an input I, an output O and a storage space S. For the foams to be rendered, a size of the storage space S is fixed, the input I is accumulated per frame, and the storage space S is filled until it is full. The output O subtracts a certain value from the pool per frame. This can complete the setup of the pool. In order to make the pool better describe the generation rule of the foams to be rendered, the target motion data, that is, the foam generation rate, may be used as the input I. The predetermined foam dissipation rate of the user is determined as O.

Therefore, based on the above foam inventory pool, when the interaction of the user is more severe and the foam generation rate is greater than the foam dissipation rate, the foams in the foam inventory pool gradually increases. Accordingly, the effect of the foam layer gradually thickening can be presented. When the interactive operation amplitude of the user is relatively slow, or when the user stops the interactive operation, the foam generation rate is less than the foam dissipation rate, the foams in the foam inventory pool gradually decreases, and the foam layer is gradually thinned until the foams are completely dissipated.

According to the method of liquid rendering provided by the embodiment, the foam inventory pool is constructed based the foam generation rate and the foam dissipation rate, so that the rendering operation of the foams to be rendered is more consistent with the effect in actual application, the authenticity and the display effect of liquid rendering are improved, and the user experience can be improved.

Optionally, on the basis of any of the foregoing embodiments, the content to be rendered includes bubbles to be rendered generated by the liquid to be rendered in response to the interactive operation. The target motion data includes a bubble speed increment. The control data includes a bubble speed decrement.

The calculating target rendering data for rendering predetermined content to be rendered based on the target motion data and user predetermined control data includes:
Constructing a bubble rate pool based on the bubble speed increment and the bubble speed decrement, wherein the bubble rate pool includes a rising speed of bubbles in each time frame.

In the embodiment, the content to be rendered includes bubbles to be rendered generated by the liquid to be rendered response interactive operation. The target motion data includes the bubble speed increment. The bubble speed increment may be proportional to the shaking severity of the liquid to be rendered, that is, the more severe the shaking, the greater the bubble speed increment. The control data includes the bubble speed decrement. The bubble speed decrement may be set by the user according to actual requirements. The bubble rate pool may be constructed based on the bubble speed increment and the bubble speed decrement, where the bubble rate pool includes a rise speed of the bubbles in each time frame.

When the bubble speed increment is greater than the bubble speed decrement, the rise rate of the foams to be rendered becomes faster. When the bubble speed increment is less than the bubble speed decrement, the rise rate of the foams becomes slower. Therefore, the bubbles to be rendered in the liquid to be rendered can be consistent with the motion state of the bubble in the actual liquid.

According to the method of liquid rendering provided by the embodiment, the bubble rate pool is constructed based on the bubble speed increment and the bubble speed decrement, so that the authenticity of liquid rendering can be improved subsequently, and the display effect of the liquid rendering operation is improved.

Optionally, on the basis of any of the foregoing embodiments, the content to be rendered includes liquid to be rendered.

Calculating the target rendering data for rendering the predetermined content to be rendered based on the target accumulation sum includes:
determining target turbidity corresponding to the target accumulation sum based on a predetermined correspondence between an accumulation sum and turbidity of the liquid to be rendered, and determining the target turbidity as the target rendering data.

In the embodiment, analyzing the physical phenomenon of liquid shaking can be found that as the bubbles are generated, the liquid gradually becomes turbid. Therefore, in order to accurately render the liquid to be rendered, the target accumulation sum and the corresponding target turbidity may be determined based on the target accumulation sum, and the predetermined correspondence between the accumulation sum and the turbidity of the liquid to be rendered, and the target turbidity is determined as the target rendering data. Therefore, after rendering based on the target rendering data, when the liquid to be rendered shakes more severely based on the interactive operation of the user, the more turbid the liquid to be rendered.

According to the method of liquid rendering provided by the embodiment, the target turbidity corresponding to the liquid to be rendered is determined, and the target turbidity is determined as the target rendering data, so that the turbid phenomenon caused by liquid shaking in actual application can be accurately simulated. Therefore, the authenticity of the rendering operation of the content to be rendered can be improved.

Further, on the basis of any of the foregoing embodiments, the content to be rendered includes liquid to be rendered. Step 103 includes:
performing color mixing rendering operation on a predetermined shallow water region and a predetermined deep-water region in the liquid to be rendered based on the target rendering data.

In the embodiment, the shallow water region and the deep-water region may be defined based on the distance from each location in the liquid to be rendered to the liquid level, and different colors may be set for the deep water region and the shallow water region. For example, the shallow water region may be defined as red and the deep-water region may be defined as blue. When the liquid to be rendered is static, a layered effect is presented, and when shaking in response to an interactive operation of the user, color mixing may be performed.

Correspondingly, the predetermined shallow water region and the predetermined deep-water region in the liquid to be rendered may be subjected to color mixing rendering operation based on the target rendering data.

Further, on the basis of any of the above embodiments, the target rendering data further includes a target turbidity corresponding to the liquid to be rendered.

The method further comprises: after performing the color mixing rendering operation on the predetermined shallow water region and the predetermined deep water region in the liquid to be rendered based on the target rendering data:
adjusting a transparency corresponding to the liquid to be rendered based on the target turbidity, wherein the target turbidity is inversely proportional to the transparency.

In the embodiment, the target rendering data further includes a target turbidity corresponding to the liquid to be rendered. The transparency corresponding to the liquid to be rendered may be adjusted based on the target turbidity, that is, the transparency of Alpha is adjusted. The target turbidity is inversely proportional to the transparency, that is, the higher the turbidity, the lower the transparency. Conversely, the lower the turbidity, the higher the transparency.

According to the method of liquid rendering provided by the embodiment, different colors are set for the predetermined shallow water region and the predetermined deep water region in the liquid to be rendered, in the rendering process, colors of the shallow water region and the deep water region are mixed based on the target rendering data, and the target turbidity of the liquid to be rendered is adjusted based on the target rendering data, so that display effects can be achieved that more severe the motion is, the higher the turbidity is, the more consistent the liquid color is, the lower the transparency is, the more static the water body is, the lower the turbidity is, the more obvious the color layering is, and the higher the transparency is.

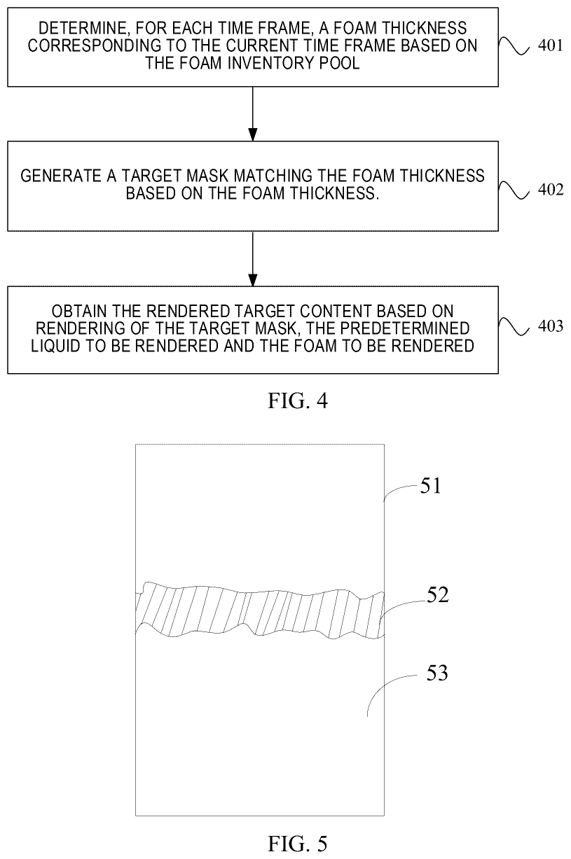

FIG. 4 is a schematic flowchart of a method of liquid rendering according to another embodiment of the disclosure. On the basis of any of the foregoing embodiments, the content to be rendered included foam to be rendered generated by the liquid to be rendered in response to the interactive operation. The target rendering data includes a foam inventory pool. As shown in FIG. 4, Step 103 includes:
Step 401: determine, for each time frame, a foam thickness corresponding to the current time frame based on the foam inventory pool.
Step 402: generate a target mask matching the foam thickness based on the foam thickness.
Step 403: obtain the rendered target content based on rendering of the target mask, the predetermined liquid to be rendered and the foam to be rendered.

In the embodiment, the content to be rendered includes foams to be rendered generated by the liquid to be rendered response interactive operation. The target rendering data includes a foam inventory pool. Based on the foam inventory pool, the foam thickness corresponding to each time frame may be determined. Based on the foam thickness, a target mask can be generated that matches foam thickness. The target mask includes a foam region and a liquid region, wherein the pixel values of the foam region and the liquid region are different. For example, the pixel value of the foam region may be 1, and the pixel value of the liquid region may be 0. When the foam to be rendered region needs to be rendered, the target mask may be multiplied with the foam texture map. When the liquid to be rendered region needs be rendered, (1−target mask) may be multiplied with the liquid to be rendered texture map. Obtaining rendered target content.

FIG. 5 is a schematic diagram of a target mask according to an embodiment of the disclosure, as shown in FIG. 5, the target mask 51 includes a foam region 52 and a liquid region 53. A thickness of the foam region 52 is H. In the target mask 51, pixel values of the foam region 52 and the liquid region 53 are different.

Optionally, in order to further improve the rendering effect, since the surface of the foam and the intersection between the foam and the liquid are often not a standard plane, the timing change may be introduced to create the pattern to effect variations in the shape of the foam edges.

According to the method of liquid rendering provided by the embodiment, the foam thickness corresponding to the current time frame is determined based the foam inventory pool, and the target mask is constructed based the foam thickness, so that the rendering operation on the foam to be rendered can be accurately performed based on the target mask. The authenticity of the foam to be rendered rendering is improved.

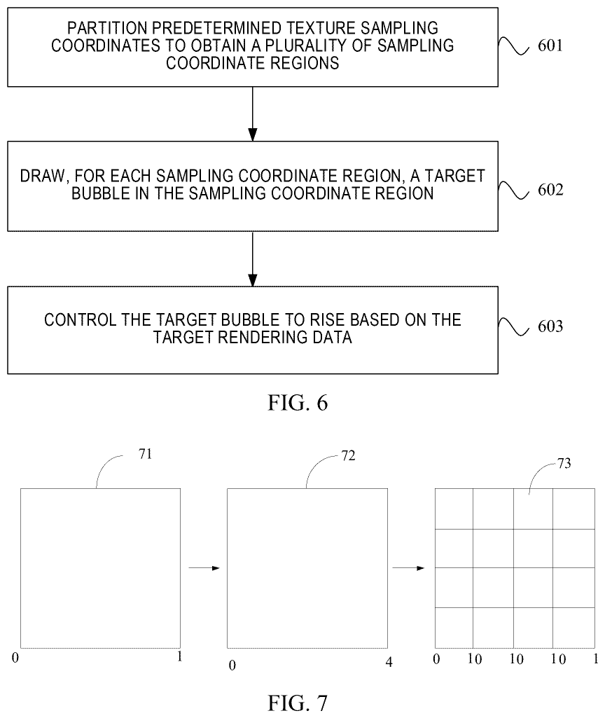

FIG. 6 is a schematic flowchart of a method of liquid rendering according to another embodiment of the disclosure. On the basis of any of the foregoing embodiments, the content to be rendered includes bubbles to be rendered generated by the liquid to be rendered in response to the interactive operation, and the target rendering data includes a bubble rate pool. As shown in FIG. 6, Step 103 includes:
Step 601: partition predetermined texture sampling coordinates to obtain a plurality of sampling coordinate regions.
Step 602: draw, for each sampling coordinate region, a target bubble in the sampling coordinate region.
Step 603: control the target bubble to rise based on the target rendering data.

In the embodiment, the rendering of the bubble to be rendered may be implemented in the texture sampling coordinate. Since the texture sampling coordinates are generally within (0, 1), in order to render the effect of the bubbles to be rendered, first, the predetermined texture sampling coordinates may be partitioned to obtain a plurality of sampling coordinate regions.

Within each sampling coordinate region, a target bubble may be drawn, and the target bubble is controlled to rise based on the target rendering data.

Further, on the basis of any of the foregoing embodiments, as shown in FIG. 6, Step 601 includes:
multiply the texture sampling coordinates by a predetermined magnification factor to obtain processed texture sampling coordinates.
take a remainder corresponding to a predetermined value for the processed texture sampling coordinates to obtain the plurality of sampling coordinate regions.

In the embodiment, the texture sampling coordinates generally belong to a (0, 1) interval, and the texture sampling coordinates may be multiplied by a predetermined magnification factor to obtain processed texture sampling coordinates. The predetermined amplification factor may be set by the user according to actual requirements. Alternatively, it may also be determined based on the target rendering data. For example, if the generation speed of the bubbles to be rendered is relatively fast, the number of the corresponding bubbles to be rendered may be more.

Further, taking a remainder corresponding to a predetermined value for the processed texture sampling coordinates to obtain the plurality of sampling coordinate regions. The predetermined value may be 1, so that a plurality of sampling coordinate regions belonging to a (0, 1) interval can be obtained.

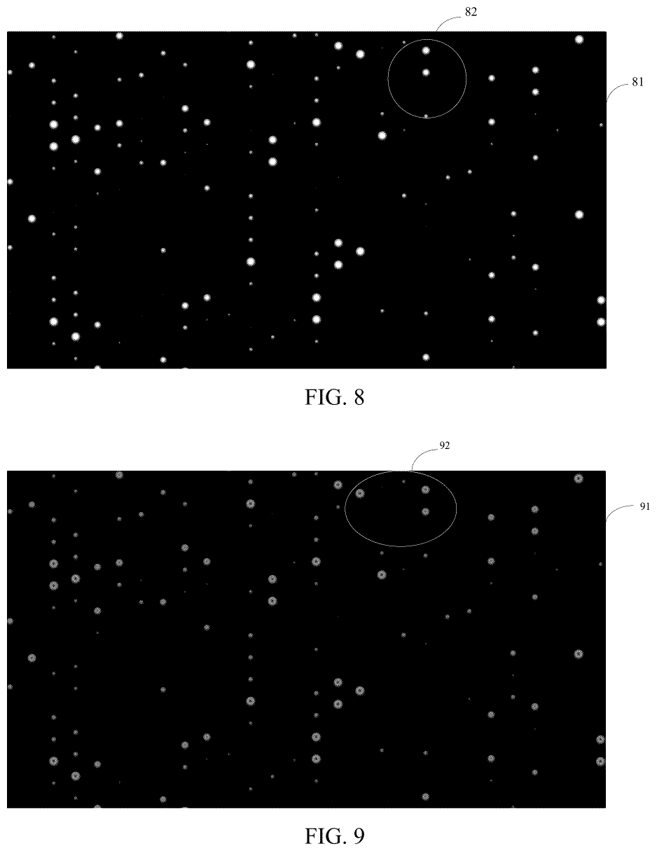

FIG. 7 is a schematic diagram of texture sampling coordinate division according to an embodiment of the disclosure. As shown in FIG. 7, the texture sampling coordinates 71 belong to a (0, 1) interval, and the texture sampling coordinates may be multiplied by a predetermined magnification factor to obtain processed texture sampling coordinates 72. For example, the predetermined magnification factor may be 4, and the processed texture sampling coordinates 72 belong to a (0, 4) interval. A remainder corresponding to the predetermined value is taken for the processed texture sampling coordinate 72 to obtain a plurality of sampling coordinate regions 73. The predetermined value may be 1.

According to the method of liquid rendering provided by the embodiment, the texture sampling coordinates are divided into a plurality of sampling coordinate regions, the target bubbles are respectively drawn in the plurality of sampling coordinate regions, the target bubbles are controlled to rise based on the target rendering data, the bubbles to be rendered can be accurately presented in the liquid to be rendered based on the interactive operation of the user, and the display effect of the liquid rendering operation is enriched. In addition, the motion process of the bubbles to be rendered is matched with the interactive operation of the user, and the authenticity of liquid rendering is improved.

Further, on the basis of any of the foregoing embodiments, Step 602 includes:
for each sampling coordinate region, draw a first bubble to be processed with a first size and a second bubble to be processed with a second size in the sampling coordinate region, respectively, wherein the first size is greater than the second size.

Perform a subtraction operation on the first bubble to be processed and the second bubble to be processed to obtain a third bubble to be processed.

Perform a coordinate transformation operation on the sampling coordinate region based on a predetermined transformation scale for each sampling coordinate region to obtain a size transformed sampling coordinate region.

For each size transformed sampling coordinate region, draw a fourth bubble to be processed with a third size in the size transformed sampling coordinate region, where the third size is smaller than the second size.

Perform a superimposition operation on the third bubble to be processed and the fourth bubble to be processed to obtain the target bubble.

In the embodiment, the display effect of the bubbles in the actual application is generally that there is a hollow region in the middle and a highlight region exists on the outer side. Therefore, in order to improve the authenticity of the target bubble, the first bubble to be processed with the first size and the second bubble to be processed with the second size can be first drawn in each sampling coordinate region. The first size is larger than the second size.

FIG. 8 is a schematic diagram of a first bubble to be processed according to an embodiment of the disclosure. As shown in FIG. 8, in each sampling coordinate region 81, a first bubble to be processed 82 may be drawn. Optionally, the first bubble to be processed 82 may be multiplied with the target parameter corresponding to the sampling coordinate region to present a non-uniform display effect.

Because the size of the first bubble to be processed is different from the size of the second bubble to be processed, a subtraction operation is performed on the first bubble to be processed and the second bubble to be processed to obtain the third bubble to be processed. Therefore, the third bubble to be processed can present a display effect in which a hollow region exists in the middle.

FIG. 9 is a schematic diagram of a third bubble to be processed according to an embodiment of the disclosure. As shown in FIG. 9, a third bubble to be processed 92 can be displayed in each sampling coordinate region 91 by perform a subtraction operation on the first bubble to be processed and the second bubble to be processed, wherein the third bubble to be processed 92 includes a hollow region therein.

Further, the highlight regions of the bubbles are generally on the sides of the bubbles. Therefore, for each sampling coordinate region, a coordinate transformation operation is performed on the sampling coordinate region based on a predetermined transformation scale, to obtain a size transformed sampling coordinate region. For each size transformed sampling coordinate region, a fourth bubble to be processed with a third size is drawn in the size transformed sampling coordinate region, where the third size is smaller than the second size. The third bubble to be processed is superimposed with the fourth bubble to be processed, that is, the highlight region is superimposed on the third bubble to be processed to obtain the target bubble. A target region including a hollow region and a highlight region can be obtained.

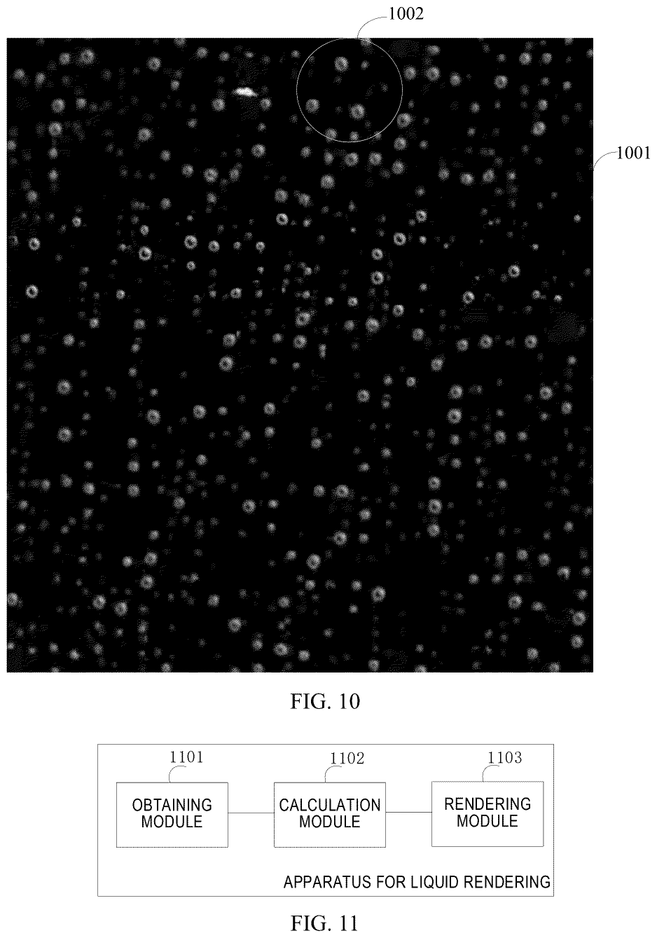

FIG. 10 is a schematic diagram of a target bubble according to an embodiment of the disclosure. As shown in FIG. 10, a target bubble 1002 may be displayed in each sampling coordinate region 1001, wherein the target bubble 1002 includes a hollow region and a highlight region.

According to the method of liquid rendering provided by the embodiment, the first bubble to be processed and the second bubble to be processed of different sizes are respectively drawn, so that the third bubble to be processed with the hollow region in the middle can be obtained. Further, by performing the coordinate transformation operation on the sampling coordinate region based on the predetermined transformation scale, the fourth bubble to be processed is drawn based on the size transformed sampling coordinate region, so that the highlight region can be superimposed on the third bubble to be processed to obtain the target bubble including the hollow region and the highlight region, so that the authenticity of the target bubble can be improved, and the display effect of the content to be rendered is improved.

Further, on the basis of any of the foregoing embodiments, after Step 602, the method further includes:
for each sampling coordinate region, calculate a target parameter corresponding to the sampling coordinate region based on a coordinate value corresponding to the sampling coordinate region.
perform a multiplication operation on the target bubble and the target parameter in each sampling coordinate region, so that the target bubble size in each sampling coordinate region is different.

In the embodiment, due to the fact that in practical applications, the sizes of bubbles generated by liquid shaking are different. Therefore, in order to improve the target bubble obtained by rendering more realistic, for each sampling coordinate region, the target parameter corresponding to the sampling coordinate region is calculated based the coordinate value corresponding to the sampling coordinate region. For example, if the coordinate value corresponding to the sampling coordinate region is (1, 1), the target parameter 1 may be obtained through 1*1. If the coordinate value corresponding to the sampling coordinate region is (2, 2), the target parameter 4 may be obtained through 2*2. Since the coordinate values corresponding to each sampling coordinate region are different, the target parameter corresponding to each sampling coordinate region is also different.

The target bubble in each sampling coordinate region is multiplied with the target parameter, so that the target bubble size in each sampling coordinate region is different.

Optionally, the operation of processing the bubble by using the target parameter may be performed after the first bubble to be processed and the second bubble to be processed are drawn, or may be performed after the target bubble is obtained, which is not limited in the disclosure.

According to the liquid rendering method provided by the embodiment, the target parameter corresponding to each sampling coordinate region is determined, and the target bubble in each sampling coordinate region is subjected to multiplication operation with the target parameter, so that the target bubble size in each sampling coordinate region is different, the display effect of the target bubble is further improved, and the authenticity of the target bubble is improved.

Further, on the basis of any of the foregoing embodiments, after Step 602, the method further includes:
extract, for each sampling coordinate region, a Berlin noise map.
perform data processing on the target bubble drawn in the sampling coordinate region based on the Berlin noise map to obtain target bubbles with irregular sizes.

In the embodiment, due to actual application, bubbles generated by shaking of the liquid are irregular. Therefore, in order to further improve the authenticity of the target bubble, for each sampling coordinate region, the Berlin noise map may be extracted. Data processing is performed on the target bubbles in the sampling coordinate region based on the Berlin noise map to obtain target bubbles with irregular sizes.

According to the method of liquid rendering provided by the embodiment, the Berlin noise map is extracted based on each sampling coordinate region, and target bubbles are drawn in the sampling coordinate region for data processing according to the extracted Berlin noise map, so that target bubbles with irregular sizes can be obtained, the display effect of the target bubbles is further improved, and the authenticity of the target bubbles is improved.

Further, on the basis of any of the foregoing embodiments, Step 603 includes:
determine, for each time frame, a rising speed of bubbles corresponding to the time frame based on the bubble rate pool;
determine an offset value of the target bubble in a longitudinal direction based on the rising speed and the time frame; and
control the target bubble to rise based on the offset value in the longitudinal direction.

In the embodiment, a time may be used as an offset value in the v direction in the uv to achieve the effect of target bubbles rising. Specifically, for each time frame, a rising speed of a bubble corresponding to the time frame is determined based on the bubble rate pool. Determining an offset value of the target bubble based on the rising speed and the time frame. Controlling the target bubble to rise based on the longitudinal offset value. That is, the original uv value (uv.u, uv.v) of the target bubble may be adjusted to (uv.u, uv.v+time*speed). Where time is a time frame, and speed is a rising speed of the bubbles.

According to the method of liquid rendering provided in the embodiment, the rising speed of the bubble corresponding to the time frame is determined based the bubble rate pool, and the offset value of the target bubble in longitudinal direction is determined based on the rising speed and the time frame. The target bubble is controlled to rise based on the longitudinal offset value, so that the target bubble can achieve a rising effect, and the display effect of the liquid to be rendered is enriched.

FIG. 11 is a schematic structural diagram of an apparatus for liquid rendering according to an embodiment of the disclosure. As shown in FIG. 11, the apparatus includes: an obtaining module 1101, a calculation module 1102 and a rendering module 1103. The obtaining module 1101 is configured to, in response to a liquid rendering request triggered by a user, obtain initial data generated based on an interactive operation triggered by the user. The calculation module 1102 is configured to calculate, based on the initial data, target rendering data for rendering predetermined content to be rendered, wherein the content to be rendered comprises liquid to be rendered and at least one object to be rendered generated by the liquid to be rendered in response to the interactive operation. The rendering module 1103 is configured to render the content to be rendered based on the target rendering data to obtain rendered target content.

Further, on the basis of any of the foregoing embodiments, the obtaining module is configured to: in response to the liquid rendering request triggered by a movement operation of the user on a terminal device, collect, by a predetermined sensor in the terminal device, motion data of the terminal device in a moving process. The motion data is determined as the initial data, wherein the motion data comprises spatial pose transformation information and motion speed information.

Further, on the basis of any of the foregoing embodiments, the calculation module is configured to: preprocess the initial data to obtain data to be calculated corresponding to each time frame during a process of the interactive operation. Calculate a target difference between data to be calculated of two adjacent frames to obtain a plurality of target differences corresponding to the interactive operation. Calculate a target accumulation sum corresponding to the plurality of target differences. Calculate the target rendering data for rendering the predetermined content to be rendered based on the target accumulation sum.

Further, on the basis of any of the foregoing embodiments, the calculation module is configured to: determine target motion data corresponding to the target accumulation sum based on a predetermined correspondence between an accumulation sum and motion data of the content to be rendered. Calculate, based on the target motion data and user predetermined control data, the target rendering data for rendering the predetermined content to be rendered.

Further, on the basis of any of the foregoing embodiments, the content to be rendered includes liquid to be rendered and/or foam to be rendered generated by the liquid to be rendered in response to the interactive operation. The initial data includes motion speed information. The calculation module is configured to: for any movement point of the liquid to be rendered perpendicular to the surface of the liquid, calculate, based on a position vector from the movement point to a predetermined target point in the liquid to be rendered and a velocity vector of the movement point, tension information of the movement point on the predetermined target point in each time frame, and determine the tension information as the data to be calculated.

Further, on the basis of any of the foregoing embodiments, the content to be rendered includes bubbles to be rendered generated by the liquid to be rendered in response to the interactive operation. The initial data includes spatial pose transformation information. The calculation module is configured to extract a rotation Euler angle in a predetermined direction in each time frame from the spatial pose transformation information and determine the rotation Euler angle as the data to be calculated.

Further, on the basis of any of the foregoing embodiments, the content to be rendered includes foams to be rendered generated by the liquid to be rendered in response to the interactive operation. The target motion data includes a foam generation rate. The control data includes a foam dissipation rate. The calculation module is configured to construct a foam inventory pool based on the foam generation rate and the foam dissipation rate, the foam inventory pool including a thickness of foam layer in each time frame.

Further, on the basis of any of the foregoing embodiments, the content to be rendered includes bubbles to be rendered generated by the liquid to be rendered in response to the interactive operation. The target motion data includes a bubble speed increment. The control data includes a bubble speed decrement. The calculation module is configured to construct a bubble rate pool based on the bubble speed increment and the bubble speed decrement, wherein the bubble rate pool includes a rising speed of bubbles in each time frame.

Further, on the basis of any of the foregoing embodiments, the content to be rendered includes liquid to be rendered. The calculation module is configured to determine target turbidity corresponding to the target accumulation sum based on a predetermined correspondence between an accumulation sum and turbidity of the liquid to be rendered, and determine the target turbidity as the target rendering data.

Further, on the basis of any of the foregoing embodiments, the content to be rendered includes liquid to be rendered. The rendering module is configured to perform color mixing rendering operation on a predetermined shallow water region and a predetermined deep-water region in the liquid to be rendered based on the target rendering data.

Further, on the basis of any of the foregoing embodiments, the target rendering data further includes a target turbidity corresponding to the liquid to be rendered. The apparatus further includes: an adjustment module, configured to adjust a transparency corresponding to the liquid to be rendered based on the target turbidity, wherein the target turbidity is inversely proportional to the transparency.

Further, on the basis of any of the foregoing embodiments, the content to be rendered included foam to be rendered generated by the liquid to be rendered in response to the interactive operation. The target rendering data includes a foam inventory pool. The rendering module is configured to: determine, for each time frame, a foam thickness corresponding to the current time frame based on the foam inventory pool. Generate a target mask matching the foam thickness based on the foam thickness. Obtain the rendered target content based on rendering of the target mask, the predetermined liquid to be rendered and the foam to be rendered.

Further, on the basis of any of the foregoing embodiments, the content to be rendered includes bubbles to be rendered generated by the liquid to be rendered in response to the interactive operation, and the target rendering data includes a bubble rate pool. The rendering module is configured to partition predetermined texture sampling coordinates to obtain a plurality of sampling coordinate regions. Draw, for each sampling coordinate region, a target bubble in the sampling coordinate region. Control the target bubble to rise based on the target rendering data.

Further, on the basis of any of the foregoing embodiments, the rendering module is configured to multiply the texture sampling coordinates by a predetermined magnification factor to obtain processed texture sampling coordinates. Take a remainder corresponding to a predetermined value for the processed texture sampling coordinates to obtain the plurality of sampling coordinate regions.

Further, on the basis of any of the foregoing embodiments, the rendering module is configured to: for each sampling coordinate region, draw a first bubble to be processed with a first size and a second bubble to be processed with a second size in the sampling coordinate region, respectively, wherein the first size is greater than the second size. Perform a subtraction operation on the first bubble to be processed and the second bubble to be processed to obtain a third bubble to be processed. Perform a coordinate transformation operation on the sampling coordinate region based on a predetermined transformation scale for each sampling coordinate region to obtain a size transformed sampling coordinate region. For each size transformed sampling coordinate region, draw a fourth bubble to be processed with a third size in the size transformed sampling coordinate region, where the third size is smaller than the second size. Perform a superimposition operation on the third bubble to be processed and the fourth bubble to be processed to obtain the target bubble.

Further, on the basis of any of the foregoing embodiments, the rendering module is further configured to: extract, for each sampling coordinate region, a Berlin noise map. Perform data processing on the target bubble drawn in the sampling coordinate region based on the Berlin noise map to obtain target bubbles with irregular sizes.

Further, on the basis of any of the foregoing embodiments, the rendering module is configured to: determine, for each time frame, a rising speed of bubbles corresponding to the time frame based on the bubble rate pool. Determine an offset value of the target bubble in a longitudinal direction based on the rising speed and the time frame; and control the target bubble to rise based on the offset value in the longitudinal direction.

The device provided in the embodiment may be configured to perform the technical solutions in the foregoing method embodiments, and implementation principles and technical effects thereof are similar, and details are not described herein again in the embodiment.

In order to implement the foregoing embodiments, an embodiment of the disclosure further provides an electronic device, comprising: a processor and a memory;
the memory storing computer executable instructions;
wherein the processor executes the computer executable instructions stored in the memory to cause the processor to execute the method of liquid rendering of any of the foregoing embodiments.

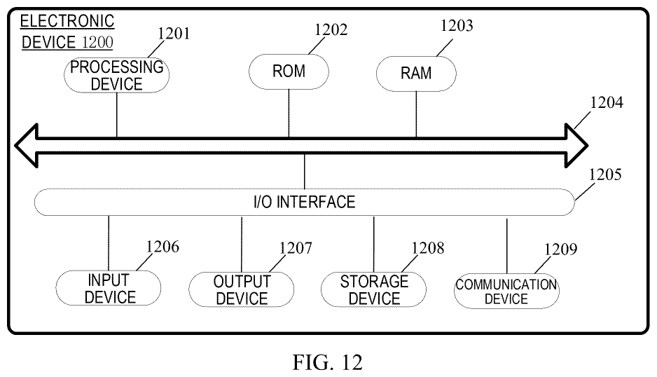

FIG. 12 is a schematic structural diagram of an electronic device according to an embodiment of the disclosure. As shown in FIG. 12, the electronic device 1200 may be a terminal device or a server. The terminal device may include, but is not limited to, a mobile terminal such as a mobile phone, a notebook computer, a digital broadcast receiver, a personal digital assistant (PDA), a tablet computer (PAD), a portable multimedia player (PMP), an in-vehicle terminal (for example, an in-vehicle navigation terminal), and a fixed terminal such as a digital TV, a desktop computer, or the like. The electronic device shown in FIG. 12 is merely an example, and should not impose any limitation on the functions and scope of use of the embodiments of the disclosure.

As shown in FIG. 12, the electronic device 1200 may include a processing device (for example, a central processing unit, a graphics processor, etc.) 1201, which may perform various appropriate actions and processing according to a program stored in a read only memory (ROM) 1202 or a program loaded into a random-access memory (RAM) 1203 from a storage device 1208. In the RAM 1203, various programs and data required by operations of the electronic device 1200 are also stored. The processing device 1201, the ROM 1202, and the RAM 1203 are connected to each other through a bus 1204. An input/output (I/O) interface 1205 is also connected to the bus 1204.

Generally, the following devices may be connected to the I/O interface 1205: an input device 1206 including, for example, a touch screen, a touch pad, a keyboard, a mouse, a camera, a microphone, an accelerometer, a gyroscope, etc.; an output device 1207 including, for example, a liquid crystal display (LCD), a speaker, a vibrator, etc.; a storage device 1208 including, for example, a magnetic tape, a hard disk, etc.; and a communication device 1209. The communication device 1209 may allow the electronic device 1200 to communicate wirelessly or wired with other devices to exchange data. While FIG. 12 shows an electronic device 1200 having various devices, it should be understood that it is not required to implement or have all illustrated devices. More or fewer devices may alternatively be implemented or provided.

In particular, according to an embodiment of the disclosure, the process described above with reference to the flowchart may be implemented as a computer software program. For example, an embodiment of the disclosure includes a computer program product comprising a computer program embodied on a computer-readable medium, the computer program comprising program code for performing the method shown in the flowchart. In such embodiments, the computer program may be downloaded and installed from the network through the communication device 1209, or installed from the storage device 1208, or from the ROM 1202. When the computer program is executed by the processing device 1201, the foregoing functions defined in the method of the embodiments of the disclosure are performed.

It should be noted that the computer-readable medium described above in embodiments of the disclosure may be a computer-readable signal medium, a computer-readable storage medium, or any combination of the foregoing two. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer diskette, a hard disk, a RAM, a ROM, an erasable programmable read-only memory (EPROM) or Flash memory, an optical fiber, a portable compact disk read-only memory (CD-ROM), an optical storage device, a magnetic storage device, or any suitable combination thereof. In the disclosure, a computer-readable storage medium may be any tangible medium containing or storing a program that may be used by or in connection with an instruction execution system, apparatus, or device. In the disclosure, a computer-readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer-readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including but not limited to: wires, optical cables, Radio Frequency (RF), and the like, or any suitable combination thereof.

An embodiment of the disclosure further provides a computer readable-storage medium storing computer executable instructions, which, when executed by a processor, implement the method of liquid rendering according to any of the foregoing embodiments.

An embodiment of the disclosure further provides a computer program product, comprising a computer program, wherein the computer program, when executed by a processor, implements the method of liquid rendering according to any of the foregoing embodiments.

An embodiment of the disclosure further provides a computer program, wherein the computer program, when executed by a processor, implements the method of liquid rendering according to any of the foregoing embodiments.

The computer-readable medium described above may be included in the electronic device; or may be separately present without being assembled into the electronic device.

The computer-readable medium carries one or more programs, which, when executed by the electronic device, cause the electronic device to perform the method shown in the foregoing embodiments.

Computer program code for performing the operations of the disclosure may be written in one or more programming languages or combination thereof, including object-oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer and partially on a remote computer, or entirely on a remote computer or server. In the case of a remote computer, the remote computer may be connected to the user computer through any kind of network, including a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the disclosure may be implemented in software, or may be implemented in hardware. The name of unit does not in some way constitute a limitation on the unit itself. For example, a first obtaining unit may be further described as “a unit obtaining at least two Internet Protocol addresses”.

The functions described above may be performed, at least in part, by one or more hardware logic components. For example, without limitation, the example types of hardware logic components that may be used include: Field-Programmable Gate Array (FPGA), Application Specific Integrated Circuit (ASIC), Application Specific Standard Part (ASSP), System On Chip (SOC), Complex Programmable Logic Device (CPLD), and the like.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination of the foregoing. More specific examples of the machine-readable storage media may include electrical connections based on one or more lines, portable computer diskettes, hard disks, RAMs, ROMs, EPROMs or flash memories, optical fibers, CD-ROMs, optical storage devices, magnetic storage devices, or any suitable combination of the foregoing.

According to a first aspect, a method of liquid rendering is provided according to one or more embodiments of the disclosure, including:
in response to a liquid rendering request triggered by a user, obtaining initial data generated based on an interactive operation triggered by the user;
calculating, based on the initial data, target rendering data for rendering predetermined content to be rendered, wherein the content to be rendered comprises liquid to be rendered and at least one object to be rendered generated by the liquid to be rendered in response to the interactive operation; and
rendering the content to be rendered based on the target rendering data to obtain rendered target content.

According to one or more embodiments of the disclosure, in response to the liquid rendering request triggered by the user, obtaining the initial data generated based on the interactive operation triggered by the user comprises:
in response to the liquid rendering request triggered by a movement operation of the user on a terminal device, collecting, by a predetermined sensor in the terminal device, motion data of the terminal device in a moving process; and
determining the motion data as the initial data, wherein the motion data comprises spatial pose transformation information and motion speed information.

According to one or more embodiments of the disclosure, calculating, based on the initial data, the target rendering data for rendering the predetermined content to be rendered comprises:
preprocessing the initial data to obtain data to be calculated corresponding to each time frame during a process of the interactive operation;
calculating a target difference between data to be calculated of two adjacent frames to obtain a plurality of target differences corresponding to the interactive operation;
calculating a target accumulation sum corresponding to the plurality of target differences; and
calculating the target rendering data for rendering the predetermined content to be rendered based on the target accumulation sum.

According to one or more embodiments of the disclosure, calculating the target rendering data for rendering the predetermined content to be rendered based on the target accumulation sum comprises:
determining target motion data corresponding to the target accumulation sum based on a predetermined correspondence between an accumulation sum and motion data of the content to be rendered; and
calculating, based on the target motion data and user predetermined control data, the target rendering data for rendering the predetermined content to be rendered.

According to one or more embodiments of the disclosure, the content to be rendered includes liquid to be rendered and/or foam to be rendered generated by the liquid to be rendered in response to the interactive operation; the initial data includes motion speed information;
preprocessing the initial data to obtain data to be calculated corresponding to each time frame during a process of the interactive operation includes:
for any movement point of the liquid to be rendered perpendicular to the surface of the liquid, calculating, based on a position vector from the movement point to a predetermined target point in the liquid to be rendered and a velocity vector of the movement point, tension information of the movement point on the predetermined target point in each time frame, and determining the tension information as the data to be calculated.

According to one or more embodiments of the disclosure, the content to be rendered includes bubbles to be rendered generated by the liquid to be rendered in response to the interactive operation; the initial data includes spatial pose transformation information;
preprocessing the initial data to obtain data to be calculated corresponding to each time frame during a process of the interactive operation includes:
extracting a rotation Euler angle in a predetermined direction in each time frame from the spatial pose transformation information and determining the rotation Euler angle as the data to be calculated.

According to one or more embodiments of the disclosure, the content to be rendered includes foams to be rendered generated by the liquid to be rendered in response to the interactive operation. The target motion data includes a foam generation rate. The control data includes a foam dissipation rate;
calculating, based on the target motion data and user predetermined control data, the target rendering data for rendering the predetermined content to be rendered includes:
constructing a foam inventory pool based on the foam generation rate and the foam dissipation rate, the foam inventory pool including a thickness of foam layer in each time frame.

According to one or more embodiments of the disclosure, the content to be rendered includes bubbles to be rendered generated by the liquid to be rendered in response to the interactive operation. The target motion data includes a bubble speed increment. The control data includes a bubble speed decrement;
calculating, based on the target motion data and user predetermined control data, the target rendering data for rendering the predetermined content to be rendered includes:
constructing a bubble rate pool based on the bubble speed increment and the bubble speed decrement, wherein the bubble rate pool includes a rising speed of bubbles in each time frame.

According to one or more embodiments of the disclosure, the content to be rendered includes liquid to be rendered;
calculating the target rendering data for rendering the predetermined content to be rendered based on the target accumulation sum includes:
determining target turbidity corresponding to the target accumulation sum based on a predetermined correspondence between an accumulation sum and turbidity of the liquid to be rendered, and determining the target turbidity as the target rendering data.

According to one or more embodiments of the disclosure, the content to be rendered includes liquid to be rendered; and rendering the content to be rendered based on the target rendering data to obtain rendered target content includes:
performing color mixing rendering operation on a predetermined shallow water region and a predetermined deep-water region in the liquid to be rendered based on the target rendering data.

According to one or more embodiments of the disclosure, the target rendering data further comprises a target turbidity corresponding to the liquid to be rendered; and
the method further comprises: after performing the color mixing rendering operation on the predetermined shallow water region and the predetermined deep water region in the liquid to be rendered based on the target rendering data,
adjusting a transparency corresponding to the liquid to be rendered based on the target turbidity, wherein the target turbidity is inversely proportional to the transparency.

According to one or more embodiments of the disclosure, the content to be rendered comprises foam to be rendered generated by the liquid to be rendered in response to the interactive operation; the target rendering data comprises a foam inventory pool; and
rendering the content to be rendered based on the target rendering data comprises:
determining, for each time frame, a foam thickness corresponding to the current time frame based on the foam inventory pool;
generating a target mask matching the foam thickness based on the foam thickness; and
obtaining the rendered target content based on rendering of the target mask, the predetermined liquid to be rendered and the foam to be rendered.

According to one or more embodiments of the disclosure, the content to be rendered comprises bubbles to be rendered generated by the liquid to be rendered in response to the interactive operation, the target rendering data comprises a bubble rate pool; and
rendering the content to be rendered based on the target rendering data comprises:
partitioning predetermined texture sampling coordinates to obtain a plurality of sampling coordinate regions;
drawing, for each sampling coordinate region, a target bubble in the sampling coordinate region; and
controlling the target bubble to rise based on the target rendering data.

According to one or more embodiments of the disclosure, partitioning the predetermined texture sampling coordinates to obtain the plurality of sampling coordinate regions comprises:
multiplying the texture sampling coordinates by a predetermined magnification factor to obtain processed texture sampling coordinates; and
taking a remainder corresponding to a predetermined value for the processed texture sampling coordinates to obtain the plurality of sampling coordinate regions.

According to one or more embodiments of the disclosure, drawing the target bubble in the sampling coordinate region includes:
for each sampling coordinate region, drawing a first bubble to be processed with a first size and a second bubble to be processed with a second size in the sampling coordinate region, respectively, wherein the first size is greater than the second size;
performing a subtraction operation on the first bubble to be processed and the second bubble to be processed to obtain a third bubble to be processed;
performing a coordinate transformation operation on the sampling coordinate region based on a predetermined transformation scale for each sampling coordinate region to obtain a size transformed sampling coordinate region;
for each size transformed sampling coordinate region, drawing a fourth bubble to be processed with a third size in the size transformed sampling coordinate region, where the third size is smaller than the second size;
performing a superimposition operation on the third bubble to be processed and the fourth bubble to be processed to obtain the target bubble.

According to one or more embodiments of the disclosure, the method further includes: after drawing, for each sampling coordinate region, the target bubble in the sampling coordinate region,
calculating, for each sampling coordinate region, a target parameter corresponding to the sampling coordinate region based on a coordinate value corresponding to the sampling coordinate region; and
performing a multiplication operation on the target bubble and the target parameter in each sampling coordinate region, so that sizes of the target bubbles in the respective sampling coordinate regions are different.

According to one or more embodiments of the disclosure, the method further includes: after drawing, for each sampling coordinate region, the target bubble in the sampling coordinate region,
extracting, for each sampling coordinate region, a Berlin noise map; and
performing data processing on the target bubble drawn in the sampling coordinate region based on the Berlin noise map to obtain target bubbles with irregular sizes.

According to one or more embodiments of the disclosure, controlling the target bubble to rise based on the target rendering data comprises:
determining, for each time frame, a rising speed of bubbles corresponding to the time frame based on the bubble rate pool;
determining an offset value of the target bubble in a longitudinal direction based on the rising speed and the time frame; and
controlling the target bubble to rise based on the offset value in the longitudinal direction.

According to a second aspect, an apparatus for liquid rendering is provided according to one or more embodiments of the disclosure, including:
an obtaining module, configured to in response to a liquid rendering request triggered by a user, obtain initial data generated based on an interactive operation triggered by the user;
a calculation module, configured to calculate, based on the initial data, target rendering data for rendering predetermined content to be rendered, wherein the content to be rendered comprises liquid to be rendered and at least one object to be rendered generated by the liquid to be rendered in response to the interactive operation; and
a rendering module, configured to render the content to be rendered based on the target rendering data to obtain rendered target content.

According to one or more embodiments of the disclosure, the obtaining module is configured to:
in response to the liquid rendering request triggered by a movement operation of the user on a terminal device, collect, by a predetermined sensor in the terminal device, motion data of the terminal device in a moving process;
determine the motion data as the initial data, wherein the motion data comprises spatial pose transformation information and motion speed information.

According to one or more embodiments of the disclosure, the calculation module is configured to:
preprocess the initial data to obtain data to be calculated corresponding to each time frame during a process of the interactive operation;
calculate a target difference between data to be calculated of two adjacent frames to obtain a plurality of target differences corresponding to the interactive operation;
calculate a target accumulation sum corresponding to the plurality of target differences;
calculate the target rendering data for rendering the predetermined content to be rendered based on the target accumulation sum;

According to one or more embodiments of the disclosure, the calculation module is configured to:
determine target motion data corresponding to the target accumulation sum based on a predetermined correspondence between an accumulation sum and motion data of the content to be rendered;
calculate, based on the target motion data and user predetermined control data, the target rendering data for rendering the predetermined content to be rendered.

According to one or more embodiments of the disclosure, the content to be rendered includes liquid to be rendered and/or foam to be rendered generated by the liquid to be rendered in response to the interactive operation; the initial data includes motion speed information;
the calculation module is configured to:
for any movement point of the liquid to be rendered perpendicular to the surface of the liquid, calculate, based on a position vector from the movement point to a predetermined target point in the liquid to be rendered and a velocity vector of the movement point, tension information of the movement point on the predetermined target point in each time frame, and determine the tension information as the data to be calculated.

According to one or more embodiments of the disclosure, the content to be rendered includes bubbles to be rendered generated by the liquid to be rendered in response to the interactive operation; the initial data includes spatial pose transformation information;
the calculation module is configured to:
extract a rotation Euler angle in a predetermined direction in each time frame from the spatial pose transformation information and determine the rotation Euler angle as the data to be calculated.

According to one or more embodiments of the disclosure, the content to be rendered includes foams to be rendered generated by the liquid to be rendered in response to the interactive operation; the target motion data includes a foam generation rate; the control data includes a foam dissipation rate;
the calculation module is configured to:
construct a foam inventory pool based on the foam generation rate and the foam dissipation rate, the foam inventory pool including a thickness of foam layer in each time frame.

According to one or more embodiments of the disclosure, the content to be rendered includes bubbles to be rendered generated by the liquid to be rendered in response to the interactive operation; the target motion data includes a bubble speed increment; the control data includes a bubble speed decrement;
the calculation module is configured to:
construct a bubble rate pool based on the bubble speed increment and the bubble speed decrement, wherein the bubble rate pool includes a rising speed of bubbles in each time frame.

According to one or more embodiments of the disclosure, the content to be rendered includes liquid to be rendered;
the calculation module is configured to:
determine a target turbidity corresponding to the target accumulation sum based on a predetermined correspondence between an accumulation sum and a turbidity of the liquid to be rendered, and determine the target turbidity as the target rendering data.

According to one or more embodiments of the disclosure, the content to be rendered includes liquid to be rendered; and the rendering module is configured to:
perform color mixing rendering operation on a predetermined shallow water region and a predetermined deep-water region in the liquid to be rendered based on the target rendering data.

According to one or more embodiments of the disclosure, the target rendering data further includes a target turbidity corresponding to the liquid to be rendered;
the apparatus further includes:
an adjustment module, configured to adjust a transparency corresponding to the liquid to be rendered based on the target turbidity, wherein the target turbidity is inversely proportional to the transparency.

According to one or more embodiments of the disclosure, the content to be rendered included foam to be rendered generated by the liquid to be rendered in response to the interactive operation; the target rendering data includes a foam inventory pool;
the rendering module is configured to:
determine, for each time frame, a foam thickness corresponding to the current time frame based on the foam inventory pool;
generate a target mask matching the foam thickness based on the foam thickness;
obtain the rendered target content based on rendering of the target mask, the predetermined liquid to be rendered and the foam to be rendered.

According to one or more embodiments of the disclosure, the content to be rendered includes bubbles to be rendered generated by the liquid to be rendered in response to the interactive operation, and the target rendering data includes a bubble rate pool;
the rendering module is configured to:
partition predetermined texture sampling coordinates to obtain a plurality of sampling coordinate regions;
draw, for each sampling coordinate region, a target bubble in the sampling coordinate region;
control the target bubble to rise based on the target rendering data.

According to one or more embodiments of the disclosure, the rendering module is configured to:
multiply the texture sampling coordinates by a predetermined magnification factor to obtain processed texture sampling coordinates;
take a remainder corresponding to a predetermined value for the processed texture sampling coordinates to obtain the plurality of sampling coordinate regions.

According to one or more embodiments of the disclosure, the rendering module is configured to:
for each sampling coordinate region, draw a first bubble to be processed with a first size and a second bubble to be processed with a second size in the sampling coordinate region, respectively, wherein the first size is greater than the second size;
perform a subtraction operation on the first bubble to be processed and the second bubble to be processed to obtain a third bubble to be processed;
perform a coordinate transformation operation on the sampling coordinate region based on a predetermined transformation scale for each sampling coordinate region to obtain a size transformed sampling coordinate region;
for each size transformed sampling coordinate region, draw a fourth bubble to be processed with a third size in the size transformed sampling coordinate region, where the third size is smaller than the second size;
perform a superimposition operation on the third bubble to be processed and the fourth bubble to be processed to obtain the target bubble.

According to one or more embodiments of the disclosure, the rendering module is further configured to: extract, for each sampling coordinate region, a Berlin noise map;
perform data processing on the target bubble drawn in the sampling coordinate region based on the Berlin noise map to obtain target bubbles with irregular sizes.

According to one or more embodiments of the disclosure, the rendering module is configured to:
determine, for each time frame, a rising speed of bubbles corresponding to the time frame based on the bubble rate pool;
determine an offset value of the target bubble in a longitudinal direction based on the rising speed and the time frame;
control the target bubble to rise based on the offset value in the longitudinal direction.

According to a third aspect, an embodiment of the disclosure provides an electronic device, comprising: at least one processor and a memory;
the memory storing computer executable instructions;
wherein the at least one processor executes the computer executable instructions stored in the memory to cause the at least one processor to execute the method of liquid rendering according to the first aspect and various possible designs of the first aspect.

According to a fourth aspect, an embodiment of the disclosure provides a computer-readable storage medium storing computer executable instructions, which, when executed by a processor, implement the method of liquid rendering according to the first aspect and various possible designs of the first aspect.

According to a fifth aspect, an embodiment of the disclosure provides a computer program product, comprising a computer program, wherein the computer program, when executed by a processor, implements the method of liquid rendering according to the first aspect and various possible designs of the first aspect.

According to a sixth aspect, an embodiment of the disclosure provides a computer program, wherein the computer program, when executed by a processor, implements the method of liquid rendering according to the first aspect and various possible designs of the first aspect.

According to a method, an apparatus, an electronic device, a computer-readable storage medium, a computer program product and a computer program for liquid rendering provided in the embodiment, the initial data generated by the user based on the interactive operation is obtained, and the target rendering data for rendering the liquid to be rendered and the at least one object to be rendered generated by the liquid to be rendered in response to the interactive operation is generated based on the initial data, so that rendering operations on the liquid to be rendered and the at least one object to be rendered can be implemented based on the target rendering data. Different rendering effects may be displayed based on the real-time interactive operation of the user. In addition, in addition to the liquid to be rendered, the rendered at least one object to be rendered may be displayed on the display interface, so that the display effect is enriched, and the user experience is improved.

The above description is merely an illustration of the preferred embodiments of the disclosure and the principles of the application. It should be understood by those skilled in the art that the scope of the disclosure is not limited to the technical solutions of the specific combination of the above technical features and should also cover other technical solutions formed by any combination of the above technical features or their equivalent features without departing from the above disclosed concept. For example, the above features and the technical features disclosed in the disclosure (but not limited to) having similar functions are replaced with each other to form the technical solution.

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

1. A method of liquid rendering, comprising:
in response to a liquid rendering request triggered by a user, obtaining initial data generated based on an interactive operation triggered by the user;
calculating, based on the initial data, target rendering data for rendering predetermined content to be rendered, wherein the content to be rendered comprises liquid to be rendered and at least one object to be rendered generated by the liquid to be rendered in response to the interactive operation; and
rendering the content to be rendered based on the target rendering data to obtain rendered target content.

2. The method of claim 1, wherein in response to the liquid rendering request triggered by the user, obtaining the initial data generated based on the interactive operation triggered by the user comprises:
in response to the liquid rendering request triggered by a movement operation of the user on a terminal device, collecting, by a predetermined sensor in the terminal device, motion data of the terminal device in a moving process; and
determining the motion data as the initial data, wherein the motion data comprises spatial pose transformation information and motion speed information.

3. The method of claim 1, wherein calculating, based on the initial data, the target rendering data for rendering the predetermined content to be rendered comprises:
preprocessing the initial data to obtain data to be calculated corresponding to each time frame during a process of the interactive operation;
calculating a target difference between data to be calculated of two adjacent frames to obtain a plurality of target differences corresponding to the interactive operation;
calculating a target accumulation sum corresponding to the plurality of target differences; and
calculating the target rendering data for rendering the predetermined content to be rendered based on the target accumulation sum.

4. The method of claim 3, wherein calculating the target rendering data for rendering the predetermined content to be rendered based on the target accumulation sum comprises:
determining target motion data corresponding to the target accumulation sum based on a predetermined correspondence between an accumulation sum and motion data of the content to be rendered; and
calculating, based on the target motion data and user predetermined control data, the target rendering data for rendering the predetermined content to be rendered.

5. The method of claim 3, wherein the content to be rendered comprises liquid to be rendered; and
calculating the target rendering data for rendering the predetermined content to be rendered based on the target accumulation sum comprises:
determining target turbidity corresponding to the target accumulation sum based on a predetermined correspondence between an accumulation sum and turbidity of the liquid to be rendered, and determining the target turbidity as the target rendering data.

6. The method of claim 1, wherein the content to be rendered comprises liquid to be rendered; and the rendering the content to be rendered based on the target rendering data comprises:
performing color mixing rendering operation on a predetermined shallow water region and a predetermined deep-water region in the liquid to be rendered based on the target rendering data.

7. The method of claim 6, wherein the target rendering data further comprises a target turbidity corresponding to the liquid to be rendered; and
the method further comprises: after performing the color mixing rendering operation on the predetermined shallow water region and the predetermined deep water region in the liquid to be rendered based on the target rendering data,
adjusting a transparency corresponding to the liquid to be rendered based on the target turbidity, wherein the target turbidity is inversely proportional to the transparency.

8. The method of claim 1, wherein the content to be rendered comprises foam to be rendered to be rendered generated by the liquid to be rendered in response to the interactive operation; the target rendering data comprises a foam inventory pool; and
rendering the content to be rendered based on the target rendering data comprises:
determining, for each time frame, a foam thickness corresponding to the current time frame based on the foam inventory pool;
generating a target mask matching the foam thickness based on the foam thickness; and
obtaining the rendered target content based on rendering of the target mask, the predetermined liquid to be rendered and the foam to be rendered to be rendered.

9. The method of claim 1, wherein the content to be rendered comprises bubbles to be rendered generated by the liquid to be rendered in response to the interactive operation, the target rendering data comprises a bubble rate pool; and
rendering the content to be rendered based on the target rendering data comprises:
partitioning predetermined texture sampling coordinates to obtain a plurality of sampling coordinate regions;
drawing, for each sampling coordinate region, a target bubble in the sampling coordinate region; and
controlling the target bubble to rise based on the target rendering data.

10. The method of claim 9, wherein partitioning the predetermined texture sampling coordinates to obtain the plurality of sampling coordinate regions comprises:
multiplying the texture sampling coordinates by a predetermined magnification factor to obtain processed texture sampling coordinates; and
taking a remainder corresponding to a predetermined value for the processed texture sampling coordinates to obtain the plurality of sampling coordinate regions.

11. The method of claim 9, further comprising: after drawing, for each sampling coordinate region, the target bubble in the sampling coordinate region,
calculating, for each sampling coordinate region, a target parameter corresponding to the sampling coordinate region based on a coordinate value corresponding to the sampling coordinate region; and
performing a multiplication operation on the target bubble and the target parameter in each sampling coordinate region, so that sizes of the target bubbles in the respective sampling coordinate regions are different.

12. The method of claim 9, further comprising: after drawing, for each sampling coordinate region, the target bubble in the sampling coordinate region,
extracting, for each sampling coordinate region, a Berlin noise map; and
performing data processing on the target bubble drawn in the sampling coordinate region based on the Berlin noise map to obtain target bubbles with irregular sizes.

13. The method of claim 9, wherein controlling the target bubble to rise based on the target rendering data comprises:
determining, for each time frame, a rising speed of bubbles corresponding to the time frame based on the bubble rate pool;
determining an offset value of the target bubble in a longitudinal direction based on the rising speed and the time frame; and
controlling the target bubble to rise based on the offset value in the longitudinal direction.

14. (canceled)

15. An electronic device, comprising: a processor and a memory;
the memory storing computer executable instructions;
wherein the processor executes the computer executable instructions stored in the memory to cause the processor to execute acts comprising:
in response to a liquid rendering request triggered by a user, obtaining initial data generated based on an interactive operation triggered by the user;
calculating, based on the initial data, target rendering data for rendering predetermined content to be rendered, wherein the content to be rendered comprises liquid to be rendered and at least one object to be rendered generated by the liquid to be rendered in response to the interactive operation; and
rendering the content to be rendered based on the target rendering data to obtain rendered target content.

16. A non-transitory computer readable storage medium storing computer executable instructions, which, when executed by a processor, implement acts comprising:
in response to a liquid rendering request triggered by a user, obtaining initial data generated based on an interactive operation triggered by the user;
calculating, based on the initial data, target rendering data for rendering predetermined content to be rendered, wherein the content to be rendered comprises liquid to be rendered and at least one object to be rendered generated by the liquid to be rendered in response to the interactive operation; and
rendering the content to be rendered based on the target rendering data to obtain rendered target content.

17. (canceled)

18. (canceled)

19. The electronic device of claim 15, wherein in response to the liquid rendering request triggered by the user, obtaining the initial data generated based on the interactive operation triggered by the user comprises:
in response to the liquid rendering request triggered by a movement operation of the user on a terminal device, collecting, by a predetermined sensor in the terminal device, motion data of the terminal device in a moving process; and
determining the motion data as the initial data, wherein the motion data comprises spatial pose transformation information and motion speed information.

20. The electronic device of claim 15, wherein calculating, based on the initial data, the target rendering data for rendering the predetermined content to be rendered comprises:
preprocessing the initial data to obtain data to be calculated corresponding to each time frame during a process of the interactive operation;
calculating a target difference between data to be calculated of two adjacent frames to obtain a plurality of target differences corresponding to the interactive operation;
calculating a target accumulation sum corresponding to the plurality of target differences; and
calculating the target rendering data for rendering the predetermined content to be rendered based on the target accumulation sum.

21. The electronic device of claim 20, wherein calculating the target rendering data for rendering the predetermined content to be rendered based on the target accumulation sum comprises:
determining target motion data corresponding to the target accumulation sum based on a predetermined correspondence between an accumulation sum and motion data of the content to be rendered; and
calculating, based on the target motion data and user predetermined control data, the target rendering data for rendering the predetermined content to be rendered.

22. The electronic device of claim 20, wherein the content to be rendered comprises liquid to be rendered; and
calculating the target rendering data for rendering the predetermined content to be rendered based on the target accumulation sum comprises:
determining target turbidity corresponding to the target accumulation sum based on a predetermined correspondence between an accumulation sum and turbidity of the liquid to be rendered, and determining the target turbidity as the target rendering data.

23. The electronic device of claim 15, wherein the content to be rendered comprises liquid to be rendered; and the rendering the content to be rendered based on the target rendering data comprises:
performing color mixing rendering operation on a predetermined shallow water region and a predetermined deep-water region in the liquid to be rendered based on the target rendering data.
